(19) United States
(12) Patent Application Publication
(10) Pub. No.: US 2011/0010776 A1
(43) Pub. Date: Jan. 13, 2011

(54) Image Management System

(76) Inventor: Christopher Ceraolo, Boca Raton, FL (US)

Correspondence Address: JOHN C. SMITH, P.A., 4125 NW 58th LANE, BOCA RATON, FL, 33496, US

(21) Appl. No.: 12/833,962

(22) Filed: Jul. 10, 2010

Related U.S. Application Data
(60) Provisional application No. 61/224,806, filed on Jul. 10, 2009.

(51) Int. Cl. G06F 17/30; G06F 3/048; G06F 17/50; G09G 5/00

(52) U.S. Cl. 726/28; 715/838; 703/1; 345/619; 707/783; 707/E17.019

(57) ABSTRACT

A method of managing product images comprising the steps of establishing an inventory of products, obtaining a plurality of digital images of the inventory of products, storing the plurality of digital images of the inventory of products, providing a set of rules for controlling access to the plurality of digital images of the inventory of products, providing a management system for implementing the set of rules to control access to the plurality of digital images of the inventory of products based on the set of permissions granted to an authorized user, receiving an access request from a remote user via a network, determining whether the user is an authorized user who is authorized to access the plurality of digital images of the inventory of products, determining the set of permissions granted to the authorized user, and allowing the authorized user to access the plurality of digital images of the inventory of products via a network according to the set of permissions granted to the authorized user. The images are captured from multiple angles to allow the image to appear to be rotating when consecutive images are displayed. An image processing system removes background information from the image such that only the selected item appears, and alternative backgrounds may be provided to give the appearance that an object was filmed at the preselected location.

### CROSS-REFERENCE TO RELATED APPLICATIONS

This application is related to, and claims the benefit of, the co-pending provisional patent application entitled “Image Management System”, filed Jul. 10, 2009, bearing U.S. Ser. No. 61/224,806 and naming Christopher Ceraolo, the named inventor herein, as sole inventor, the contents of which is specifically incorporated by reference herein in its entirety.

### BACKGROUND

1. Technical Field

This invention relates in general to image management system, and more particularly it relates to a system that permits a user to dynamically display 360° views of inventory items via electronic display systems. A unique camera system captures 360° images of individual items. Once captured, background information is removed or replace by a software to produce a finished image that only contains the desired object and/or any desired background. Finished images are then stored in a database such that they may be accessed by one or more user applications.

2. Background of the Invention

Prior to the advent of computers, merchandising companies were limited in how they could first present displays of their products to their customers. In particular, a primary vehicle for product selection was hardcopy product catalogs. Of course, hardcopy catalogs typically provide one or two images of a particular product from a single perspective. Likewise, the images are fixed in size. This limits the amount of information given the consumer to make an intelligent choice. In addition to the limitations inherent in hardcopy catalogs and similar advertising materials, they are also expensive to produce and distribute. Another feature associated with print materials, such as catalogs, is that they tend to have a long shelf life. This is both an advantage and a disadvantage. For businesses with stable inventories, catalogs are very useful. However, in businesses where frequent changes are made to inventory, catalogs may quickly become outdated. For businesses, it would be desirable to have a method of displaying inventory items from a variety of viewpoints with a system that is dynamically updated so that only currently available inventory is presented to consumers.

Recently, the development of online merchandising and inventory management systems has created the need to dynamically update available inventory to provide more up to date data for consumers. However, present-day systems still limit the ability of consumers to view an Inventory item or product from any angle. Online systems present a limited number of views, often no better than a hard copy catalog. It would be desirable to have a system that would allow an individual to dynamically manipulate an image of an inventory items such that the consumer could examine the inventory item from any angle. This would be particularly advantageous in environments such as the Internet where a vendor may want to provide as much information as possible to a potential consumer.

In addition to sites on which an individual manufacturer may show only their product line, there are numerous sites that offer merchandise from a variety of manufacturers. In this type of environment, it would be advantageous for the manufacturer to provide superior quality images for use by the vendor. It would allow the manufacturer to supply more information to a consumer, and by so doing it would enhance sales for the manufacturer.

Because the distribution of images is typically an uncontrolled process that results in a non-uniform presentation of products and a duplication of efforts, it would be desirable to have a central location where high-quality 360° images can be supplied to multiple vendors using multiple applications. This would provide the manufacturer with greater control over what is presented to consumers, and it would reduce the effort required on the part of the vendor to prepare their websites.

Another problem related to presentation of inventory items is ensuring that the images do not have unnecessary distractions caused by unneeded background material. In the case of 360° images, background objects may seriously detract from the value of the image. It would be desirable to have a method of creating 360° images of items in which background objects can be modified or eliminated.

Accordingly, there has been a long felt need for a process that provides a company with the ability to use its creative talent to choose images of the products for specific advertising purposes without duplicating costs and efforts while maintaining a consistent product image.

While the prior art has provided a variety of ways to present images, it has failed to provide a method of creating 360° views of items in which extraneous background images have been removed, and which are stored in a centralized database that can be accessed by a variety of users in the company, and by external entities such as other vendors and/or the public.

### SUMMARY OF THE INVENTION

The present invention provides a unique system of capable of capturing multiple images at different angles that can be rotatably presented to a viewer to create the impression of an image that appears to be a 360° image. Once the images are captured, the inventory item in the captured image data is preserved and any unnecessary background information is removed or replaced. The modified image data is then saved in a central database where it can be accessed and manipulated by users from a variety of locations in an organization. The system provides a method of managing product images by establishing a product inventory, obtaining a plurality of digital images of items in the product inventory, storing the plurality of digital images of the product inventory, providing a set of rules for controlling access to the plurality of digital images of the product inventory, providing a management system for implementing the set of rules to control access to the plurality of digital images of the product inventory based on the set of permissions granted to an authorized user, receiving an access request from a remote user via a network, determining whether the user is an authorized user who is authorized to access the plurality of digital images of the product inventory, determining the set of permissions granted to the authorized user, and allowing the authorized user to access the plurality of digital images of the product inventory via a network according to the set of permissions granted to the authorized users.

### BRIEF DESCRIPTION OF THE DRAWINGS

FIG. 1 is a block diagram illustrating multiple users communicating with a server used by the invention.

FIG. 2 is a flowchart illustrating a preferred method of creating an image inventory.

FIG. 3 is a flowchart illustrating a preferred method of authorizing users and granting permissions selected activities.

FIG. 4 is a diagram illustrating user interaction with a product image.

FIG. 5 is a diagram illustrating an alternative preferred embodiment of an image selection screen that allows a user to select an image from a group of images.

FIG. 6 is a flowchart illustrating a preferred method wherein a user selects an image for use, obtains authorization to use the image, and prepares damage for use with a selected media type.

FIG. 7 illustrates a mechanical drawing used to generate virtual images.

FIG. 8 is a flowchart illustrating a preferred method extracting data from a mechanical drawing and using data to construct a virtual 3-D image.

FIG. 9A is a diagram illustrating a preferred embodiment for acquiring images.

FIG. 9B is a diagram illustrating an alternative preferred embodiment for acquiring product images.

FIG. 10 is a flowchart that illustrates a preferred method of acquiring images for the image database.

### DETAILED DESCRIPTION OF THE PREFERRED EMBODIMENT

Prior to a discussion of the figures, an overview of the invention will be presented. For ease of discussion, the term inventory is used throughout the specification to describe the items in the image database. For the purpose of this disclosure, it is understood that the term “inventory” is used to describe the item being captured. An item can be any commercial item, such as a product inventory item, a SKU number, or anything offered for sale. Further, while commercial use of the invention provides value to users, the invention is not so limited. There are innumerable non-commercial uses, such as for educational systems, news dissemination, etc. The invention is an image management system that creates an image database having a succession of related images taken at different angles. The images are displayed in succession to create the impression of rotatable 360° images. The raw images are input to a software system that extracts, replaces or modifies any background information. As a result, the 360° images contain only data from the selected items, or data with modified backgrounds. Once the system creates the images, they are stored in a central database. In addition to the 360° images, users may extract individual frames from the 360° images to be used as still photos for print media. A zoom feature allows the images to be rotated at various zoom distances to suit a particular purpose.

The system provides a unique camera system that can operate in one of two modes. In the first mode, the inventory item is at rest and the camera is rotated around the inventory item. This mode of operation is particularly useful for obtaining images of large, heavy, or unwieldy inventory items. An alternate mode of operation uses a camera that remains fixed, and the inventory item is rotated.

An advantage provided by the system is that users can interactively access the database to obtain particular images of inventory items on an as needed basis. As a result, images are created only once, but can be used for a wide variety of purposes. This increases productivity within an organization by providing centralized production facility that can be shared across multiple departments.

The present invention also provides an image management system that comprises the steps of establishing an image library, obtaining a plurality of digital inventory images, storing the plurality of digital inventory images in the image library, providing a set of rules for controlling access to the plurality of digital images in the image library, and for approving the use of a digital image for particular purpose, providing a management system for implementing the set of rules to control access to digital images in the image library based on the set of permissions granted to an authorized user, receiving an access request from a remote user via a network, determining whether the user is an authorized user who is authorized to access the plurality of digital images in the image library, determining the set of permissions granted to the authorized user, allowing the authorized user to access the plurality of digital images in the image library via a network according to the set of permissions granted to the authorized user, and allowing an authorized user to review the digital images and to select a digital image for a particular purpose. Still further, the present invention provides a method of creating an image library for an inventory of products comprising the steps of establishing an inventory of products, obtaining a plurality of digital images of the inventory of products at different angles from a plane through the center of the respective product, and storing the plurality of digital images of the inventory of products. For ease of discussion, the term “products,” as used herein, can be used to describe commercial products or any other item, such as technical information, historical records, etc.

The present invention ensures quality control over the images of the product inventory resulting in dependable image content, latest product version, and a streamlined approval process that is paperless. Accessibility to the product images and data files associated with the products is available globally. This is a substantial improvement over prior art systems, such as catalogs, in which out-of-date inventory items may often appear.

The product is searchable by part number, category, description, text in comment fields, etc. Multiple users may access and use the same database of product images and have simultaneous instant image availability. The system provides increased flexibility in choosing images for different advertising media and allows users to increase creativity. In particular it allows users to choose images from multiple angles to provide just the right product image for a particular purpose. The system also utilizes multiple delivery modes to provide downloadable, print-ready images. All departments work with a consistent set of images rather than incurring the expense and inconsistency of having photographs taken by individual departments for advertising purposes. The approval process for selection of an image for a special use is done without physical documents and is available for use by an authorized user anywhere in the world. The creation of 360-degree product renderings provides personnel with the necessary views to properly advertise any type of product.

Other advantages and applications of the present invention will be made apparent by the following detailed description of the preferred embodiment of the invention.

An important aspect of the invention is that it automatically removes extraneous background information from the 360° image. In a preferred embodiment, the background information can be rendered blank, can be a selected color, or the background image can be replaced with a suitable scene to enhance the appearance of the inventory item. For example, an inventory item related to the beach, such as scuba equipment, can be altered to include a background image of a beach to enhance the appearance of the inventory item. Likewise, fashion items such as dresses may have any suitable background from a solid color to a fashionable location, etc. The advantage of the system is that inventory items can be photographed in-house, and background material for the 360° images can be added later to create the appearance of an on-location photo.

Another optional embodiment of the invention provides the ability to extract still frames from a 360° image for use in applications such as print material.

An advantage of the invention is that the images only have to be acquired once, and once acquired they can be made accessible to any number of users without requiring any additional work on the part of the user. Further, the system provides for user customization through the use of selectable zoom angles, selectable rotation speeds, selectable background modification, and selectable still images.

Having discussed the features and advantages of the invention in general, we turn now to a detailed discussion of the figures.

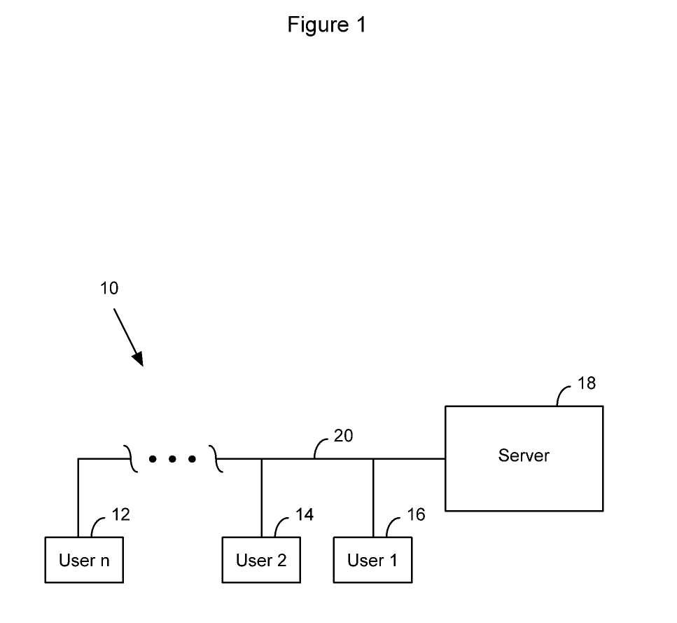

Referring to FIG. 1, the system 10 comprises a plurality of users 1-n on user computers 12, 14, and 16 connected to server 18 via communication network 20. Network 20 can be, for example, a local area network (LAN) or wide area network (WAN), such as the Internet. User computers 12, 14, and 16 can be mainframe terminals, workstation computers, desktop computers, and/or laptop computers. Further, the invention can be used with any intelligent communications device, such as smart phones (e.g., the Blackberry™, iPhone™, etc). Server 18 stores and implements a number of programs and files, such as a system control program, product inventory database, product images database, rules and permissions program and database, and product approval database. Of course, the number of user computers is only limited by capacity of server or servers 18. The product inventory database can contain a data file associated with the images of product. This data file can contain, for example, information about the product, SKU, price, and so forth. In the preferred embodiment, each authorized user 1-n on computers 12, 14, 16 can independently access any permitted image in the product inventory database.

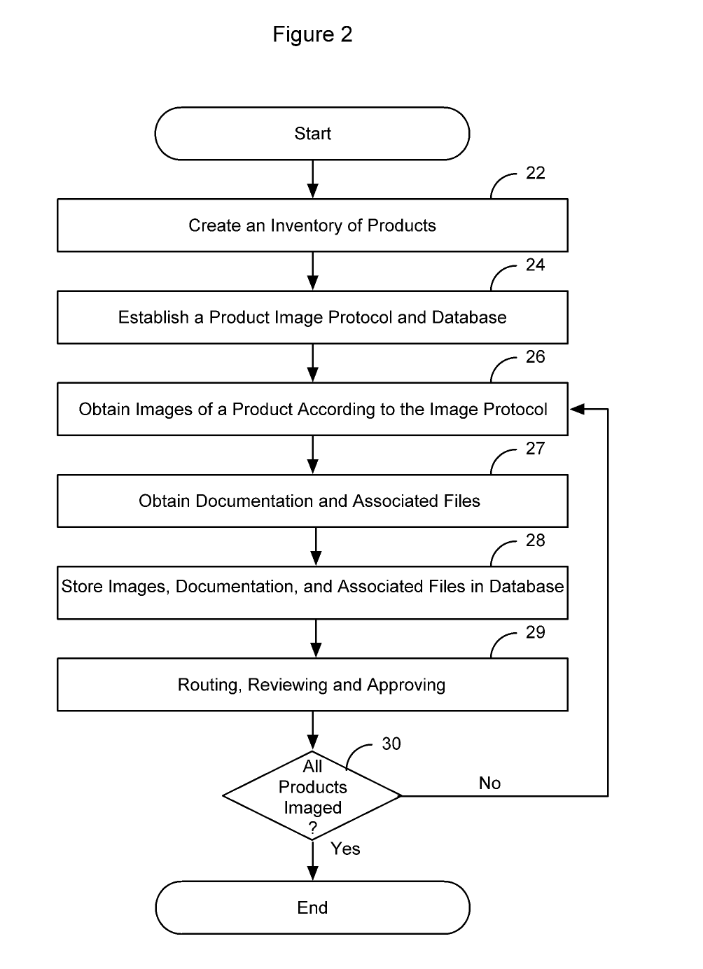

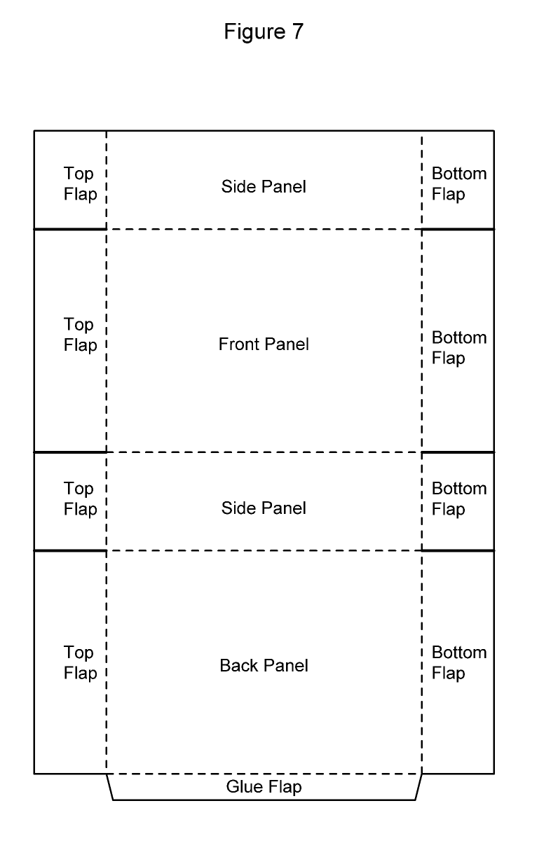

A flowchart of an overall system process for image acquisition is illustrated in FIG. 2. A detailed discussion of each step in the process will be presented in regard to the subsequent figures. At step 22 an inventory of products is created and stored in the product inventory database in server 18. A product image protocol and database is established at step 24. The product image protocol includes the criteria under which images are obtained, such as the image resolution, number of images, angles at which the images are created and so forth. In step 26, the images of a product are obtained according to the product image protocol established in step 24. Product documentation and associated files are input in step 27. The documentation and associated files may include, depending on the particular product, a variety of information such as product description, supporting documentation, product packaging, the product manual, management approval records for this product, copies of marketing and advertising materials etc. The product images, associated files and documentation are stored in the product database in step 28. At step 29, the routing, reviewing, and approving is conducted to obtain appropriate management review and approval. Although not shown in FIG. 2, any disapproval by management may require correction or reworking of the disapproved material. At the completion of this process, the images of the inventory items are available in the product inventory database. Creation of the product images is discussed in detail with reference to FIGS. 7-10.

At decision point 30, the issue of whether all products in the inventory of products have been imaged is considered. If all products have been imaged, then the process is complete. Otherwise, the process returns to step 26 to obtain images of the next product in the product inventory. The process shown in FIG. 2 is repeated whenever a new product is added to the inventory of product. Likewise, when a product is discontinued, its image is deleted from the product inventory database. Those skilled in the art will recognize that for large systems the product inventory database can be maintained locally, maintained at a remote site, distributed across several sites.

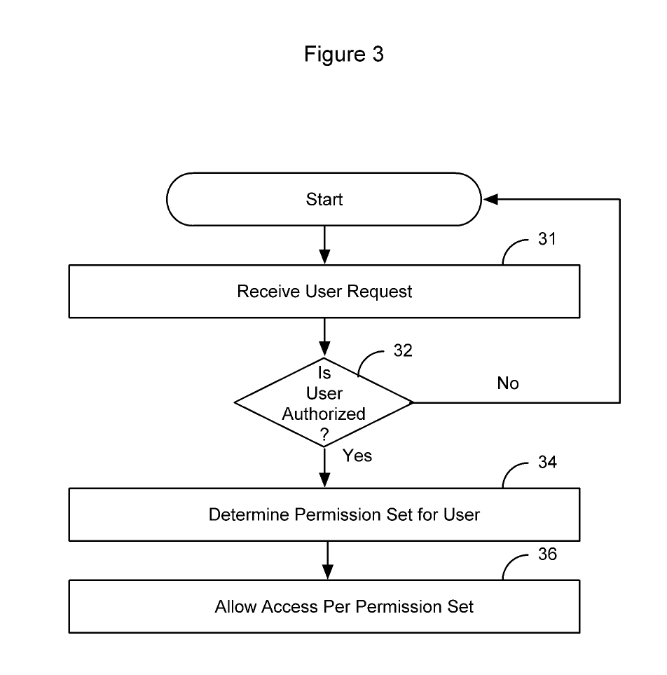

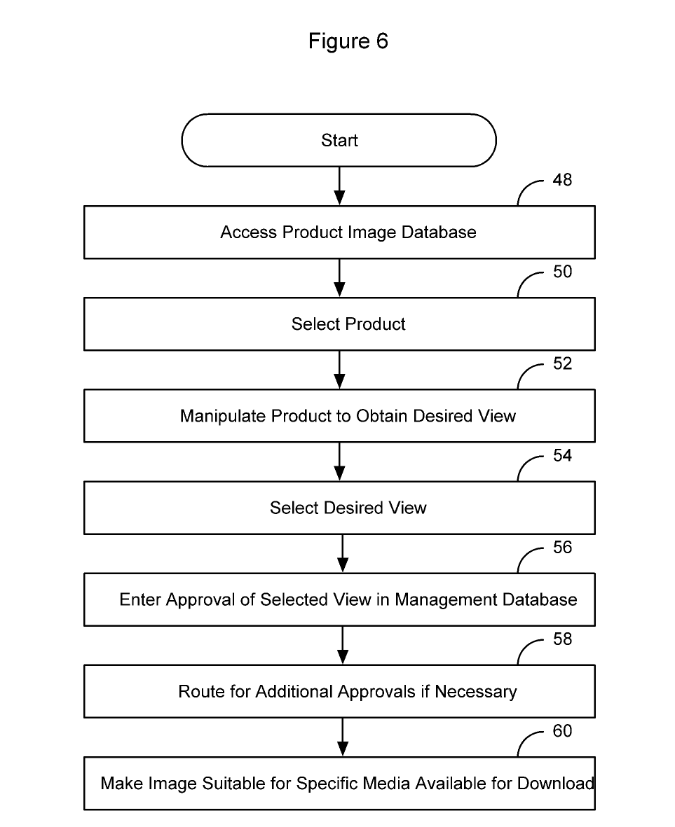

In regard to FIG. 3, this figure illustrates a preferred embodiment of a login and user approval process according to the present invention. At step 31, server 18 receives a request from a user to access a database of the system. At step 32, server 18 determines whether the user is authorized to access the selected database. If the user is not authorized, the server denies the requested access. If the user is authorized, then at step 34 the server determines the permission set for this particular user. The permission set for each authorized user is set up and controlled by a system administrator who determines what a particular user is allowed to do. This permission set can include, for example, authority to view all or only certain products, authority to approve the selection of product images for a particular advertising purpose and so forth as illustrated in FIG. 6. At step 36, server 18 allows an authorized user to access the product images, product documentation, and associated files. The database is searchable so that an authorized user can search products by part number, category, description, text in comment fields, and so forth, per the user's permission set. Once access is granted, the user can manipulate the product image on the screen to view the product from different angles or perspectives. In the preferred embodiment, images are viewed using a standards compliant web browser that supports HTML. This is a significant advantage provided by the invention because the use of a standards compliant web browser allows images to be viewed without installing any additional software on the user's computer.

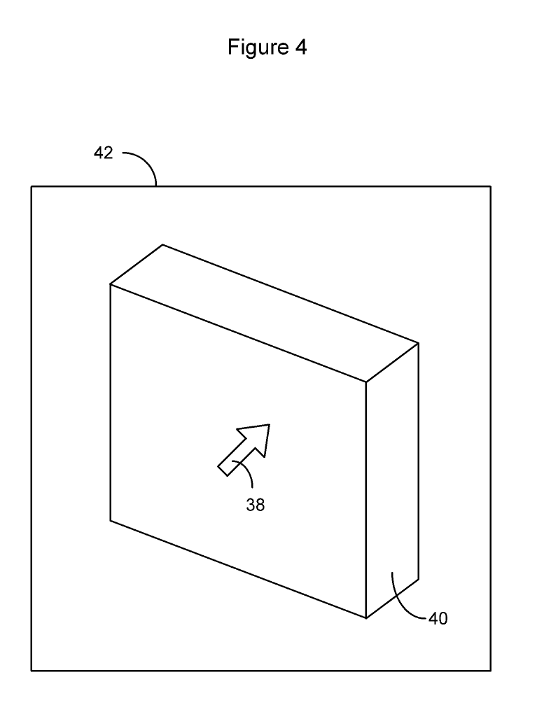

In regard to FIG. 4, this figure illustrates a monitor screen 42 displaying a product image 40. Also shown is pointer 38 that has been placed on the product image 40. Once the pointer 38 is placed on product image 40, the pointing device can be moved to rotate the product image 40 that is displayed on the monitor 42 in a desired direction. Server 18 can be programmed to automatically download the plurality of images of the product in the product image database so that as the user moves pointer 38, product image 40 changes accordingly so that the product appears to be manipulated as if the user were rotating an actual product in his hand. While the image can be manually rotated as described above, the system can also create images that are automatically zoomed and rotated to suit particular applications. For some web pages, it may be desirable to have an image that is already spinning when the page is accessed. The system provides the ability to initialize images for automatic display.

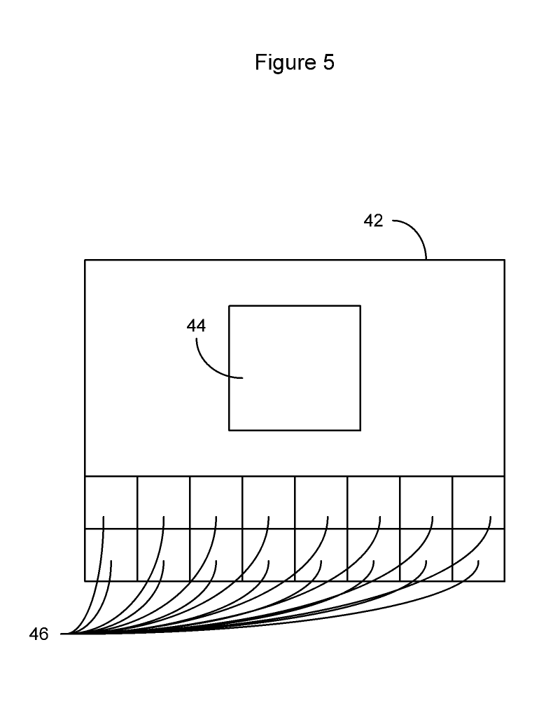

Optionally, as shown in FIG. 5, server 18 can be programmed to automatically download a primary image 44 and a number of thumbnail images 46 of the chosen product from different angles and orientations and display them on monitor 42. The user can then select any of thumbnail images 46 for viewing. In another optional alternative embodiment, the downloaded thumbnail images 46 can contain images suitable for different media, such as color, grayscale, a subtractive color model used in color printing such as CMYK, run of press (ROP) colors, high-resolution images for virtual catalogs or other digital media, etc. This embodiment allows the user to easily view product images for different media on a single screen. This further illustrates a significant advantage provided by the system in that product images can be created once and then preformatted for use by users in different parts for different media types without having to go through the process of re-creating an image.

FIG. 6 illustrates how an authorized user (as determined according to FIG. 3) selects and manipulates images. The user, if authorized to approve the selection of product images for a particular advertising purpose, proceeds as follows. At step 48 the authorized user accesses the product image database. Once the product image database is selected, the user then selects a product at step 50. In step 52, the user manipulates the product image (as described above in regard to FIGS. 4-5) and then selects the desired view in step 54. The user then approves the selected product view at step 56. The data entered into the system database can include the selected image, identification of the user selecting the image, and the date and time of approval. If additional approvals are necessary for the particular application then at step 58 server 18 routes the necessary approval to other management via network 20. When all of the necessary approvals have been obtained, server 18 downloads the product image in the suitable format for the specific media, such as for a catalog, newspaper advertisement, mailing flyer, etc, at step 60. The downloaded product image is preferably a high resolution image and is preferably available in different formats such as color, grayscale, a subtractive color model used in color printing such as CMYK, run of press (ROP) colors, high resolution images for virtual catalogs, or other digital media, etc. In the preferred embodiment, only the latest approved images are available for viewing and downloading. Prior images can be tracked and stored by appropriate personnel, but in general are not available to an authorized user.

The plurality of images of the products stored in server 18 can be generated in different ways. A first method of generating product images utilizes mechanical drawing computer files, such as the one shown in FIG. 7 for printing a box for an actual product. This mechanical drawing shows all sides of the box for the actual product. The edges of the box are shown in dotted lines, and the heavy lines on the top and bottom flaps indicate the cut lines. In some applications, a data file associated with the mechanical drawing will provide the dimensions for the box. In other applications the dimensions of the box are measured on the mechanical drawing. These dimensions are then used to create a three-dimensional virtual model in server 18 or other workstation computer. The mechanical drawing computer file illustrates the outside appearance of the product packaging, which can be applied to the exterior of a three-dimensional wire frame model as a skin to create a three-dimensional virtual product that appears to be an actual packaged product. The virtual model of the product is then rotated to a desired position and the images of the product in those positions are stored. Those skilled in the art will recognize that process can be performed locally by graphics personnel using the server or from a separate workstation. If a separate workstation is employed then the saved images of the product are uploaded to the server.

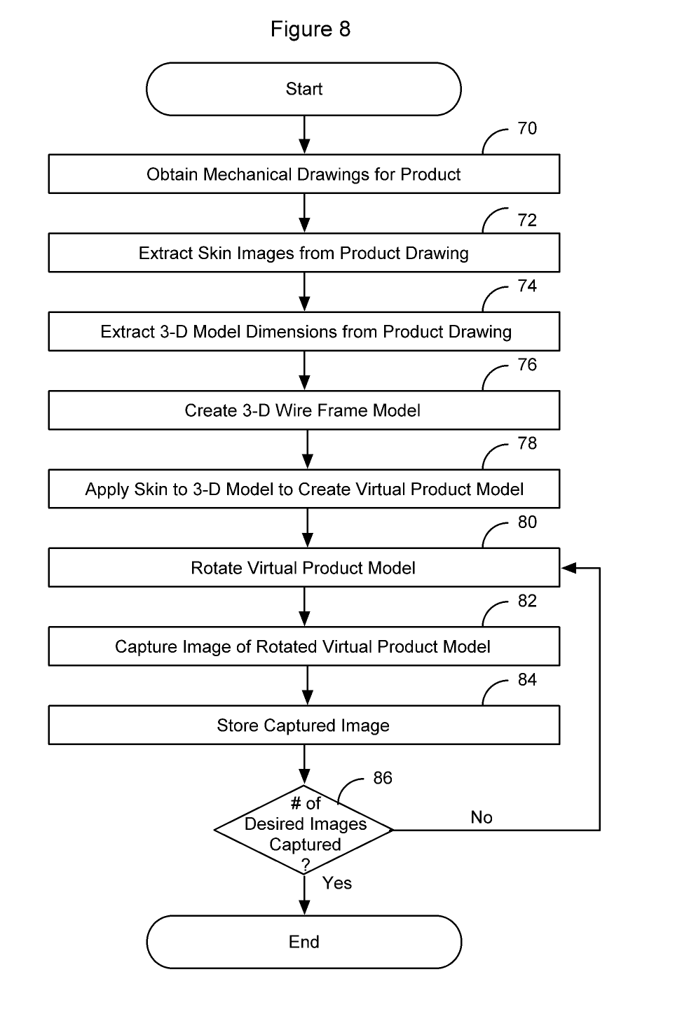

FIG. 8 illustrates a flowchart for implementing the image generation process. At step 70, a digital version of a mechanical drawing of the product is obtained. The skin images and model dimensions of the product are extracted from the mechanical drawing in steps 72 and 74 respectively using a vector graphics program. A three-dimensional wire frame model is created in step 76 by entering the model dimensions into a program to create a three-dimensional specification or wire frame model. For example, a box has three dimensions: length, width, and height. The skin images are then applied to the three-dimensional wire frame model in step 78 using a vector graphics program to create a virtual product model. The graphics personnel then rotate the virtual product model to desired positions, for example ten degree increments, in step 80, capture the image of the virtual product model in step 82 and then store it in a server, such as server 18 in FIG. 1, in step 84. At decision point 86, the graphics personnel determine if the desired number of images of the virtual product model have been captured. For example, as discussed above, rotating the virtual product model in ten-degree increments would result in 36 images in one plane. If the product is then tilted forward in five increments, this would result in five additional sets of 36 images for a total of 216 images. However, it should be understood that this is merely a business management design decision in determining how many different images should be available to the business personnel. This decision will depend on the nature of the product, for example, where the product is marketed in a box versus one that is not marketed in box. Other factors to be considered are costs and the desired appearance of the line of products in the inventory.

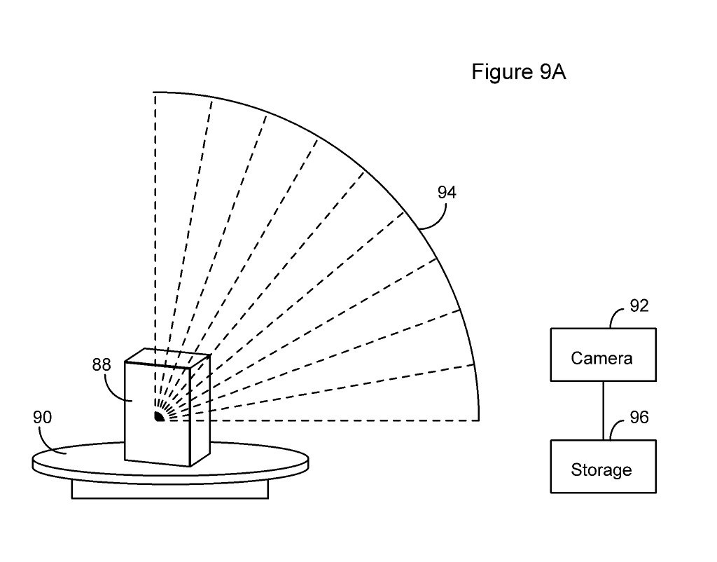

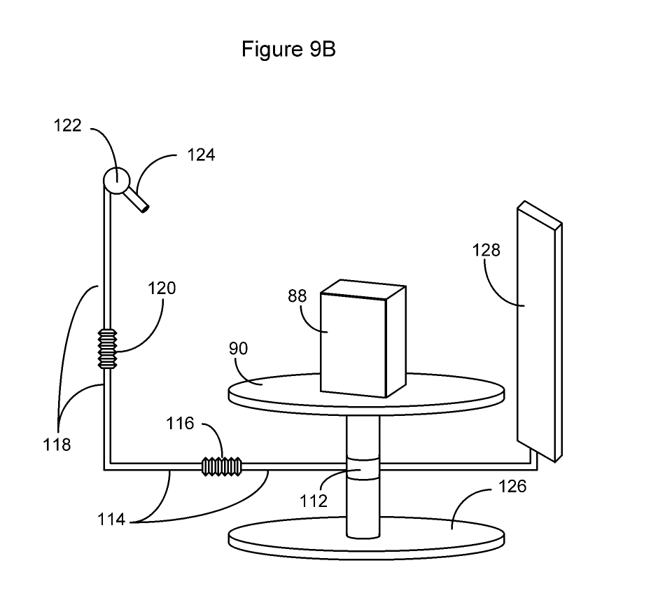

Another method of generating the plurality of images for the products in the inventory of products is illustrated in FIG. 9A. An inventory product 88 is positioned on a rotatable turntable 90. An image generator, such as camera 92 is positioned along arc 94, at predetermined positions. A jig or other suitable apparatus can be used to position camera 92 at the desired positions along arc 94. Those skilled in the art will recognize that the predetermined positions can be any number of degrees apart. The dotted lines illustrate one embodiment in which the positions are ten degrees apart. The dotted lines radiate from the approximate center of product 88. Since turntable 90 is rotatable in one plane, product 88 can be rotated a predetermined number of degrees in the horizontal plane. An image is then generated by camera 92 and provided to storage 96 for temporary storage. Turntable 90 would then be rotated again, and another image is generated by camera 92. This process is repeated until all of the desired images have been taken in this plane. The position of camera 92 along arc 94 is changed to a different position so that the images will be generated from the perspective of a second plane. This process can then be repeated for the desired number of planes. At a later point the images can be uploaded from storage 96 to the system server, such as server 18 in FIG. 1. For ease of illustration, a single camera 92 is shown this figure. However, those skilled in the art will recognize that two or more cameras can be located at predetermined points along arc 94. In addition, two or more cameras can be located around product 88 in the first plane where camera 92 is located to minimize the number of times that product 88 has to be rotated.

FIG. 9B illustrates another alternative preferred embodiment of the camera system. In this embodiment, camera stand 126 provides a fixed angular change for an inventory item 88. Adjustable pivot 112 support for horizontal arm 114 which has a horizontal extension mechanism 116 in which allows horizontal arm 114 to be extended or retracted. Similarly, vertical arm 118 can be extended or retracted by vertical extension mechanism 120. Camera 124 is attached to pivoting camera support 122, which is in turn attached to vertical arm 118. The combination of horizontal extension device 116, vertical extension device 120 and pivoting camera support 122 allow the system to dynamically adjust the position of the camera 124 in relation to the product 88. For ease of illustration, the internal robotic drive mechanisms for adjustable pivot support 112 horizontal extension device 116, vertical extension device 120 and pivoting camera support 122 have been omitted because the technology related to robotic arm movement is well known in the art.

Also shown in this figure is optional backdrop 128. Optional backdrop 128 is attached to adjustable pivot 112 via support arm 130. As a result, optional backdrop 128 rotates with camera 124 such that is always aligned behind the product to eliminate extraneous images. In addition to the use of optional backdrop 128, acquired images can also be enhanced electronically after capture to eliminate any extraneous background information. Those skilled in the art will recognize that the optional backdrop 128 can also be configured such that preselected images, for example a beach scene, can be printed on a rotatable scroll that will change as the camera 124 is rotated about the product. Likewise, optional backdrop 128 can be a high-resolution display that electronically changes as the camera 124 is moved. The image capture device can be anything suitable, such as a digital video camera, a digital still camera, a smart phone with integral camera, etc. The only requirement is that the image capture device can produce motion or still image data. In addition, the backdrop can be used as a “screen” for a rear or front projected image to be captured simultaneously with the product image.

Once the product images are captured, background images can be inserted into the image to create the appearance product is in a particular location. For example, an image of a model wearing a swimsuit can be taken at a central location. Once the images are acquired, any number of backdrop images can be inserted to make it appear that the model is at a particular location, such as a beach or swimming pool. In the preferred embodiment, the product image and backdrop images are stored separately to allow them to be combined as desired. Of course, the type of image capture device will not limit the ability of the system to modify the background portion of the images.

Manipulation of background images can be done in several ways. The background data can be eliminated entirely, it can be eliminated and replaced, or the background can be blurred to focus the viewer's attention on the object.

The image capture process captures multiple images, each taken at a different angle. Once the raw images are obtained, the images are modified to remove the background from each individual image. As a result, when the images are displayed, the images can be rotated to show a 360-degree view without any extraneous background information. In addition, the camera system preferably has sufficient resolution to allow digital zooming by the user. Of course, the zoom function allows a user to rotate an image regardless of the amount of zoom selected. Due to this, a single set of images can be collected that can be used by a variety of users for different applications, at different angles, at different zoom distances, and either motion or still images.

The use of the 360-degree images produced by the system for basic web applications is apparent. However, the system provides the ability to enhance many web applications. For example, the 360-degree imaging technology can be used to produce sophisticated imaging for banner ads. An important part of Internet advertising is the use of banner ads to attract potential customers. The 360-degree imaging system provided herein gives advertisers the ability to produce interesting eye-catching ads that will draw more users to the advertiser's website. Likewise, once the customer links to the advertiser's site, the same technology can be used to provide better information to the customer.

Those skilled in the art will recognize that in addition to rotatable 360-degree images that can be displayed on the Internet, the images stored in the database can be used with any suitable media. Not only can rotatable images be displayed on monitors, but still images can also be extracted from the database a variety of uses such as web advertisements, print media, etc. In fact, motion or still images from the database can be extracted for use with any suitable medium.

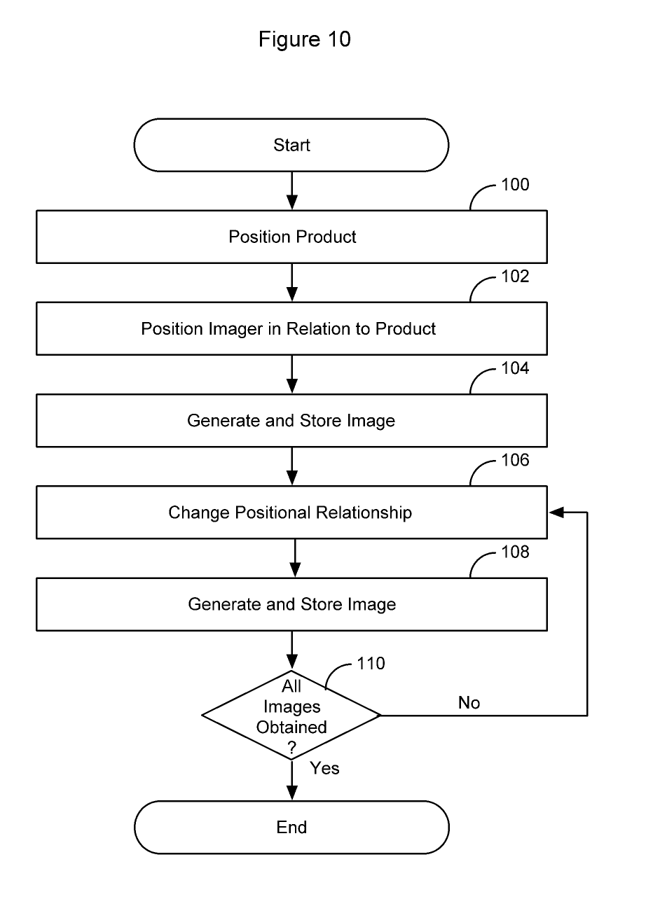

A flowchart of the imaging process is illustrated in FIG. 10. At step 100, product 88 is positioned on turntable 90. Camera 92 is then positioned along arc 94 in relation to product 88 in step 102. At step 104, the image of product 88 is generated by camera 92 and stored in storage 96. The positional relationship between camera 92 and product 88 is then changed in step 106, and another image of product 88 is generated and stored in step 108. At decision point 110 the determination is made as to whether all of the desired images have been obtained. If not, the process returns to step 106.

The images can be generated, for example, by consecutively changing the position of the product or the image generator in relation to the product by a set number of degrees. Either the product can be rotated or the camera can be moved around the product. It has been found that a change of ten degrees provides a reasonably pleasing visual effect of fluid rotation of the product, while limiting the number of images required to thirty-six in one plane. Although any number of planes can be used, it has been found that as a practical matter only four or five steps of ten degrees up or down from the horizontal plane provide satisfactory images for advertising. The result is that the product image viewed on the screen gives the user a choice of images from looking directly at the product in the same plane to tilting the product, and, of course, the option of rotating the product to see, for example, the front and right-hand side. When the product is tilted, then, for example, the image displays the front, right-hand side, and top.

Those skilled in the art will understand that the invention can be implemented by a variety of systems. While large commercial enterprises may implement the invention on mainframe or server systems, the invention can also be implemented on single systems, such as a personal computer or standalone device.

While specific embodiments have been discussed to illustrate the invention, it will be understood by those skilled in the art that variations in the embodiments can be made without departing from the spirit of the invention. For example, a wide variety of changes can be made to the robotic system that control movement of the camera or product. The camera can be dynamically controlled by a user, or controlled automatically by preprogrammed changes in angle of view of the camera. Optional backdrops can be used as blank screens, colored screens, or with images that mechanically or electronically change. The types of image related data stored in conjunction with the images can vary according to need, etc. Therefore, the invention shall be limited solely to the scope of the claims.

I claim:

1. A method of managing product images, including the steps of:
establishing an inventory of products;
obtaining a plurality of digital images of the inventory of products;
storing the plurality of digital images of the inventory of products;
providing a set of rules for controlling access to the plurality of digital images of the inventory of products;
providing a management system for implementing the set of rules to control access to the plurality of digital images of the inventory of products based on the set of permissions granted to an authorized user;
receiving an access request from a remote user via a network;
determining whether the user is an authorized user who is authorized to access the plurality of digital images of the inventory of products;
determining the set of permissions granted to the authorized user; and
allowing the authorized user to access the plurality of digital images of the inventory of products via a network according to the set of permissions granted to the authorized user.

2. A method, as in claim 1, including the additional step of obtaining a plurality of digital images for at least one product in the inventory of products.

3. A method, as in claim 2, including the step of:
Including a plurality of images of at least one product that was taken at different angles.

4. A method, as in claim 1, including the additional steps of:
allowing the authorized user to access the plurality of digital images of the inventory of products via a network according to the set of permissions granted to the authorized user; and
displaying the images on the authorized user's computer using a standards compliant web browser that supports HTML;
whereby the authorized user views the plurality of digital images of the inventory products at the authorized user's remote computer without installing additional software to the authorized user's remote computer.

5. A method, as in claim 1, including the additional steps of:
downloading a plurality of different digital images a respective product when the authorized user requests one of the digital images of the respective product;
displaying thumbnail images of the plurality of different digital images in one area of the screen, and;
displaying a full-size image of a particular thumbnail image when that thumbnail image is selected.

6. A method, as in claim 1, including the additional steps of:
storing a data file associated with the inventory of products;
establishing a set of rules for controlling access to the data file;
controlling access to the data file associated with the inventory of products based on the set of permissions granted to an authorized user.

7. A method, as in claim 1, including the additional step of:
deleting background information from the digital image such that only product images remain in the digital image.

8. A method, as in claim 7, including the additional step of:
adding background information from the digital image such that the product images remain in the digital image appear to be at a preselected location.

9. A method of managing an image database, including the additional steps of:
establishing an image database for an inventory of products;
obtaining a plurality of digital images of an inventory of products;
storing the plurality of digital images of the inventory of products in the image database;
providing a set of rules for controlling access to the plurality of digital images of the inventory of products and for approving the use of a digital image of a product for particular purpose;
determining if a user is authorized to access the image database based on the set of rules;
allowing the authorized user to access at least a portion of the image database based on the set of permissions granted to the authorized user;
and allowing an authorized user to review the digital images of a product and to select a digital image for a particular purpose.

10. A method, as in claim 9, including the additional step of:
allowing the authorized user to manipulate the image of the product on the authorized user's computer screen so that the authorized user can view the product from different perspectives and to select a digital image for a particular purpose.

11. A method, as in claim 10, including the additional step of:
when a image is selected by an authorized user for a particular purpose, requesting approval when approval is required according to the set of rules.

12. A method, as in claim 11, including the additional step of:
using the digital image selected by an authorized user in one or more media types.

13. A method, as in claim 12, including the additional step of:
recording the time and date of the approval, the authorized user, and the approver that approved the selection of the digital image.

14. A method, as in claim 12, including the additional step of:
Determining which media type in which a particular selected digital image will be used; and
downloading the selected digital image in a format suitable for use in a particular media.

15. A method, as in claim 9, wherein:
at least some of the plurality of digital images of the inventory of products are a collection to images of the same product at different angles from a plane through the center of that product.

16. A method, as in claim 15, further comprising the additional step of:
the collection to images of the same product are obtained at predetermined angular amounts on a plane through the center of that product.

17. A method, as in claim 16, including the additional steps of:
obtaining a first set of images for the collection to images of the same product at predetermined angular amounts on a first plane through the center of that product;
obtaining a second set of images for the collection to images of the same product at predetermined angular amounts on a second plane through the center of that product; and
obtaining a third set of images for the collection to images of the same product at predetermined angular amounts on a third plane through the center of that product.

18. A method, as in claim 9, further comprising the additional steps of:
inputting a drawing of a respective product;
extracting skin images and three dimensional model dimensions from the drawing;
using a computer to create a three dimensional model from the three dimensional model dimensions;
applying the skin images to the three dimensional model to create a virtual product model;
rotating the virtual product model to create images of the virtual product at different angles; and
storing the created images of the virtual product.

19. A method, as in claim 9, including the additional step of:
deleting background information from the digital image such that only product images remain in the digital image.

20. A method, as in claim 19, including the additional step of:
adding background information from the digital image such that the product images remain in the digital image appear to be at a preselected location.
